(19) United States
(12) Patent Application Publication
(10) Pub. No.: US 2016/0205005 A1
(43) Pub. Date: Jul. 14, 2016

(54) METHOD OF PROCESSING TRAFFIC TO RECOVER SERVICE CHAIN PATH, SERVICE FUNCTION FORWARDING NODE USING THE SAME, AND NETWORK SYSTEM USING THE SAME

(71) Applicant: ELECTRONICS AND TELECOMMUNICATIONS RESEARCH INSTITUTE, Daejeon (KR)

(72) Inventor: Seung-Ik LEE, Daejeon (KR)

(73) Assignee: ELECTRONICS AND TELECOMMUNICATIONS RESEARCH INSTITUTE, Daejeon (KR)

(21) Appl. No.: 14/993,233

(22) Filed: Jan. 12, 2016

(30) Foreign Application Priority Data
Jan. 14, 2015 (KR) 10-2015-0006585

(51) Int. Cl. H04L 12/26

(52) U.S. Cl. CPC H04L 43/0823

(57) ABSTRACT

There is provided a method in which a Service Function Forwarding node (SFF) processes traffic. The SFF determines whether a first Service Function Instant (SFI) is in the state of being able to process traffic. The first SFI is locally connected to the SFF, and implements a Service Function (SF) for the processing of traffic. It is determined whether the first SFI is in the state of being able to process traffic. When the first SFI is in the state of being unable to process traffic, the processing of the traffic is requested from a second SFI in which the same SF has been implemented.

### CROSS-REFERENCE TO RELATED APPLICATION

This application claims the benefit of Korean Patent Application No. 10-2015-0006585, filed Jan. 14, 2015, which is hereby incorporated by reference herein in its entirety.

### BACKGROUND

1. Technical Field

The present disclosure relates generally to network service and, more particularly, to a method and apparatus for processing traffic to recover a service chain path, in which a failure has occurred, in a network system.

2. Description of the Related Art

To construct a service-aware network infrastructure, open networking and network virtualization technologies have been required. To support this new era of network technology, a Network Function Virtualization (NFV) technology has been introduced. NFV is a technology that can flexibly deploy Service Functions (SFs) by virtualizing the component functions for network services, which were provided by hardware, in a software way.

A plurality of use cases based on NFV has been introduced. One of these use cases is a Virtual Network Function (VNF) forwarding graph. A VNF forwarding graph selectively connects and executes network functions required to serve different types of traffic. A VNF forwarding graph can configure a single network service by combining a plurality of virtualized network component functions in a predetermined sequence.

Generally, a network service is provided by a combination of pieces of network equipment that implement one or more network component functions. In other words, network equipment can provide a component network function which may be deployed in various network layers and at various network locations. A network service can be composed by these network functions. Examples of such component network functions include an enterprise access router, a firewall and Deep Packet Inspection (DPI) that provide network infrastructure functions, and a Dynamic Host Configuration Protocol (DHCP), Network Address Translation (NAT) and Universal Plug and Play (uPnP) that provide a network service within a home.

A service chaining (or SF chaining) technology can provide the aforementioned NFV functionalities in the existing network infrastructure in a software manner. Service chaining can implement a single network service by selectively combining and executing service functions (SFs) required to serve different types of traffic. In other words, service chaining can exploit the existing physical network equipment for network service composition based on the concept of a VNF forwarding graph while NFV exploits virtual network functions. A service function path is further built to define an order of the component network functions for traffic flow traversals. This path can be dynamically configured and actively controlled.

### SUMMARY

At least one embodiment of the present invention is intended to, when an SFI is in the state of being unable to process traffic, process the traffic using another SFI that implements an SF identical to an SF that is implemented by the former SFI.

At least one embodiment of the present invention is intended to recover an SFP for traffic by using another SFI in place of an SFI in the state of being unable to process the traffic.

At least one embodiment of the present invention is intended to recover an SFP via interaction between SFFs.

In accordance with an aspect of the present invention, there is provided a method in which a Service Function Forwarding node (SFF) processes traffic, the method including: determining whether a first Service Function Instance (SFI) that is locally connected to the SFF and implements a Service Function (SF) intended for the processing of traffic is in the state of being able to process the traffic; and requesting the processing of the traffic to a second SFI in which the SF has been implemented when the first SFI is in the state of being unable to process the traffic.

The first SFI may be an SFI that is selected in accordance with a Service Function Path (SFP) for the traffic.

The SFF recovers a Service Function Path (SFP) for the traffic by allowing the second SFI to process the traffic on behalf of the first SFI that is in the state of being unable to process the traffic.

The method may further include requesting a connection to the first SFI.

The SFF may determine that the first SFI is in the state of being unable to process the traffic when a timeout for the connection request occurs.

The method may further include requesting a connection to the first SFI.

The SFF may determine that the first SFI is in the state of being unable to process the traffic when the SFF receives the rejection of the connection request from the first SFI.

The SFF may select the second SFI from at least one SFI locally connected to the SFF.

The second SFI may be a remote SFI that is connected to a remote SFF.

The method may further include obtaining a list of SFIs connected to other SFFs.

The second SFI may be an SFI within the list.

The SFF may obtain the list via overlay network communications with the other SFFs.

The SFF may obtain the list via a communications with control plane components which have centralized orchestration capabilities.

The requesting may include transmitting a request for the processing of the traffic to the remote SFF.

The requesting may further include receiving the result of the processing of the traffic from the remote SFF, and transmitting the result to a next SFF in accordance with an SFP for the traffic.

The result of the processing of the traffic may be transmitted by the remote SFF directly to a next SFF specified in a SFP for the traffic.

The method may further include selecting one out of one or more SFFs as the remote SFF in accordance with a predetermined criterion.

The remote SFF may be an SFF that exhibits a best performance among the one or more SFFs in the processing of the traffic.

An SFF that has requested the processing of the traffic from the SFF among the one or more SFFs may be excluded from the selection as the remote SFF.

The number of the remote SFFs may be plural.

The SFF may request the processing of the traffic to the plurality of remote SFFs via broadcasting.

The method may further include updating an SFP for the traffic so that the second SFI is used in place of the first SFI, and transmitting the data of the updated SFP to a traffic classification node.

In accordance with another aspect of the present invention, there is provided a Service Function Forwarding node (SFF), including: a processing unit configured to detect whether a first Service Function Instance (SFI) that is locally connected to the SFF and implements a Service Function (SF) intended for the processing of traffic is in the state of being able to process the traffic; and a communication unit configured to request the processing of the traffic from a second SFI in which the SF has been implemented.

In accordance with still another aspect of the present invention, there is provided a network system including a plurality of Service Function Forwarding nodes (SFFs), the network system including: a first Service Function Forwarding node (SFF) locally connected to a first Service Function Instance (SFI) that implements a Service Function (SF) for the processing of traffic; and a second SFI locally connected to a second SFF in which the SF has been implemented; wherein the first SFF detects the first SFI being in the state of being unable to process the traffic, and requests the processing of the traffic to the second SFF when there is no other SFI implementing the SF and locally connected to the first SFI; and wherein the second SFF processes the traffic using the second SFI.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a VNF forwarding graph according to an example;

FIG. 2 illustrates service chaining according to an example;

FIG. 3 illustrates the network model and basic components of a service chaining technology according to an example;

FIG. 4 shows the failure of an SFC attributable to the failure of an SF according to an example;

FIG. 5 shows the control of an SFP according to an example;

FIG. 6 is a block diagram of an SFF according to an embodiment;

FIG. 7 shows a network system according to an embodiment;

FIG. 8 is a flowchart of a method by which an SFF processes traffic according to an embodiment;

FIG. 9 shows a service chain according to an example;

FIG. 10 illustrates the processing of traffic using a recursive call method according to an example;

FIG. 11 illustrates the processing of traffic using retransmission according to an example;

FIG. 12 illustrates the processing of traffic using repeated retransmission according to an example;

FIG. 13 illustrates the processing of traffic using broadcasting according to an example; and

FIG. 14 illustrates the update of an SFP according to an example.

### DETAILED DESCRIPTION

Embodiments of the present invention will be described in detail below with reference to the accompanying drawings. Redundant descriptions and descriptions of well-known functions and configurations that have been deemed to make the gist of the present invention unnecessarily obscure will be omitted. The embodiments of the present invention are intended to fully describe the present invention to persons having ordinary knowledge in the art to which the present invention pertains. Accordingly, the shapes, sizes, etc. of components in the drawings may be exaggerated to make the description obvious.

Embodiments of the present invention are described in detail with reference to the accompanying diagrams.

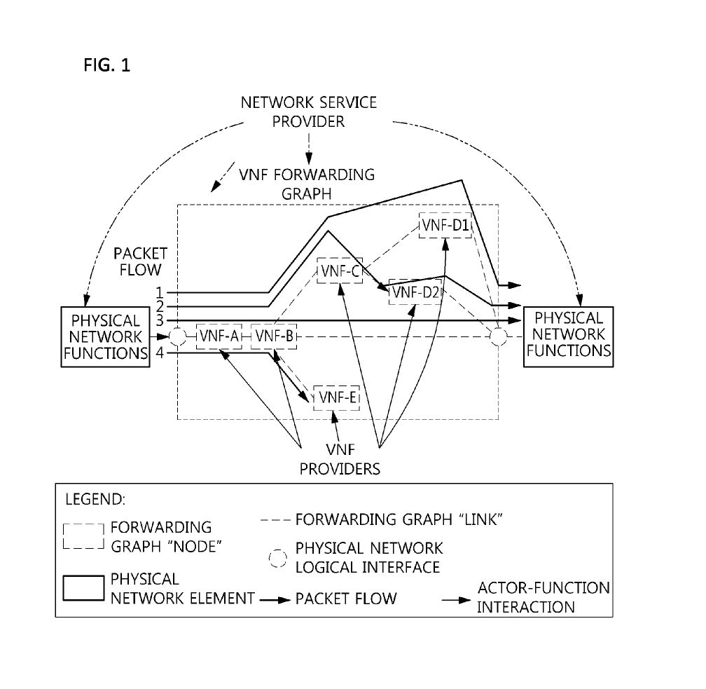

FIG. 1 illustrates a VNF forwarding graph according to an example.

In the legend of FIG. 1, symbols used in FIG. 1 are described. The nodes of the NVF forward graph are represented by dotted-line boxes. The links of the VNF forwarding graph are presented by dotted lines. The physical network logical interfaces of the VNF forwarding graph are presented by dotted-line circles. The physical network components of the VNF forwarding graph are presented by solid-line boxes. The packet flows of the VNF forwarding graph are presented by thick arrows. Furthermore, the actor-function interaction of the VNF forwarding graph are presented by thin arrows.

In FIG. 1, network functions provided by a network service provider are shown. The network service provider may provide physical network functions, and may provide the functions of the VNF forwarding graph.

The VNF forwarding graph may include VNF instance. In FIG. 1, VNF-A, VNF-B, VNF-C, VNF-D1, VNF-D2 and VNF-E are illustrated as the VNF instances by way of example.

In FIG. 1, four packet flows are illustrated by way of example. The respective packet flows may be processed along different paths in the VNF forwarding graph. The packet flows may be processed through actor-function interaction with the VNF providers in the nodes of the VNF forwarding graph.

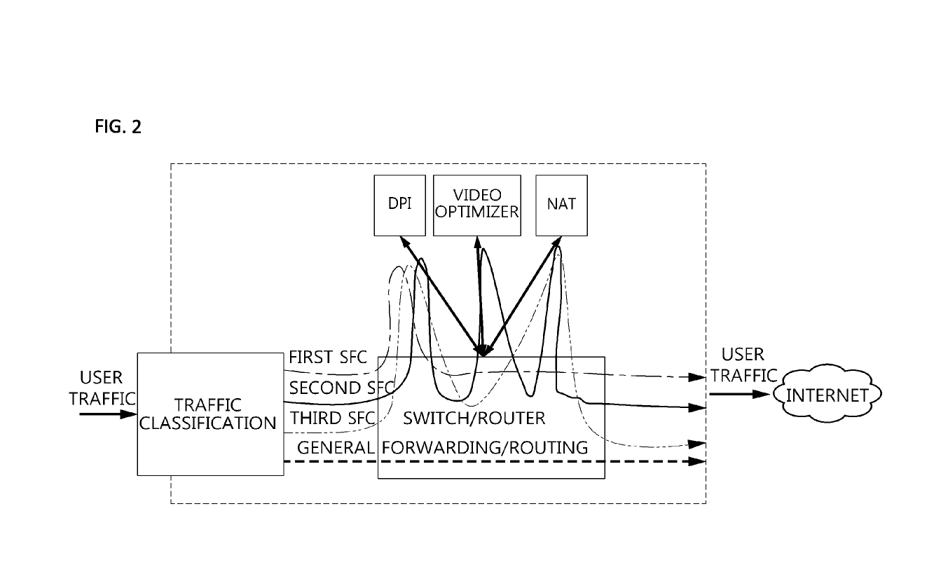

FIG. 2 illustrates service chaining according to an example.

When the traffic of a user is transmitted to a network, Traffic Classification (CLSF) may be performed in compliance with a predetermined policy, a specific Service Function Chain (SFC) may be selected for the traffic based on the traffic classification. A first SFC, a second SFC and a third SFC are shown as the SFC that can be selected in FIG. 2. Furthermore, general forward/routing is shown in FIG. 2. In the following, the CLSF may refer to a device, node or terminal that performs traffic classification.

Once the SFC has been selected, the traffic of the user may be sequentially forwarded to SFs in a predetermined order in accordance with the SFC selected via a switch and/or a router, and may be processed by the SFs. After the forwarding and the processing, the traffic may be transmitted to a subsequent destination, such as the Internet. In FIG. 2, the traffic of the user is illustrated as being sequentially forwarded to and processed by the SFs of a DPI, a video optimizer, and a NAT.

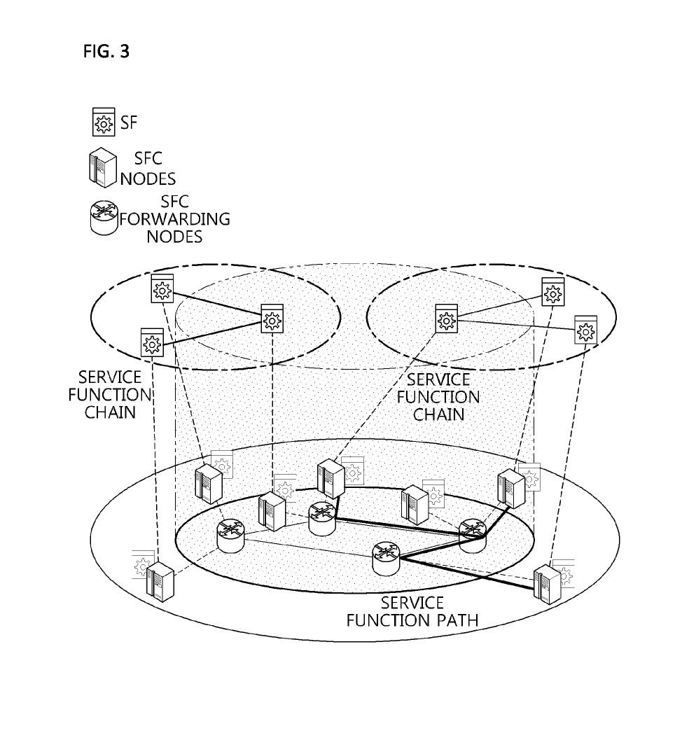

The network model and basic components of a service chaining technology defined for an operation, such as the operation described above, are described with reference to FIG. 3 below.

FIG. 3 illustrates the network model and basic components of a service chaining technology according to an example.

An SF may be a component function constituting part of a network service, and may process a single packet or a single stream of traffic. The SF may refer to the logical entity of a function. A Service Function Instance (SFI) may be an entity or terminal that has implemented an SF for the actual operation of the SF. Furthermore, the SFI may be installed and executed on network resources shared in a software way or on physically dedicated equipment. Furthermore, one or more SFIs may be present to implement a single SF.

A Service Node (SN) may be a node connected to a network. The SN may be an entity on which one or more SFIs can be installed and which can execute one or more SFIs. The SFI may receive traffic from the network via the SN, and forwards processed traffic to the network via the SN. In the following, the terms “SFI” and “SN” may be used interchangeably.

An SFC is a logical path that represents one or more SFs processing a packet or traffic and the order of the SFs. The SFC may be defined in compliance with a network service policy. An SFC may be selected per traffic by CLSF.

A Service Function Path (SFP) refers to the instance of a logically defined SFC. The SFP may be a result obtained by mapping a logical service chain to actual SFIs, physical service nodes, etc. on a network. The SFP may be a path along which a network packet and traffic are actually forwarded.

A Service Function Forwarding node (SFF) may be an entity that enables a network packet and traffic to be forwarded in the order of an SFP by interconnecting SFIs defined in the SFP.

The VNF forwarding graph based on NFV and the SFC based on service function chaining may be different from each other in terms of the virtualization of an SF and the support of a legacy service function. And, the VNF forwarding graph and the SFC may be the same as each other in terms of the concept that a combination of services is provided through the ordering of basic SFs. Since the following exemplary embodiments relate to the configuration and reconfiguration of a service chain that are common to NFV and service function chaining, they may be applied to both NFV and service function chaining regardless of the terms used.

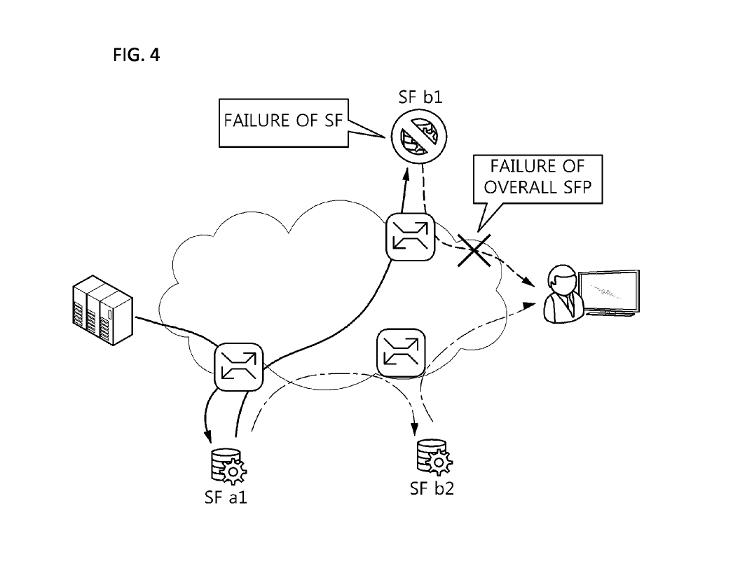

FIG. 4 shows the failure of an SFC attributable to the failure of an SF according to an example.

In FIG. 4, a first SF a1, a first SF b1, and a second SF b2 are illustrated as SFs that process traffic. The traffic having reached a network may be sequentially processed by the SF a1 and the SF b1 along an SFP.

The performance or operational state of the SFP may be determined depending on the performance and states of the SFIs. As shown in FIG. 4, the failure of the overall SFP may occur due to the SF b1. In other words, the failure of the service chain may occur due to a failure in a single SFI of the SFP. Furthermore, when an SFI cannot normally operate because an excessive work load is assigned to the SFI, the failure of the overall SFP may occur.

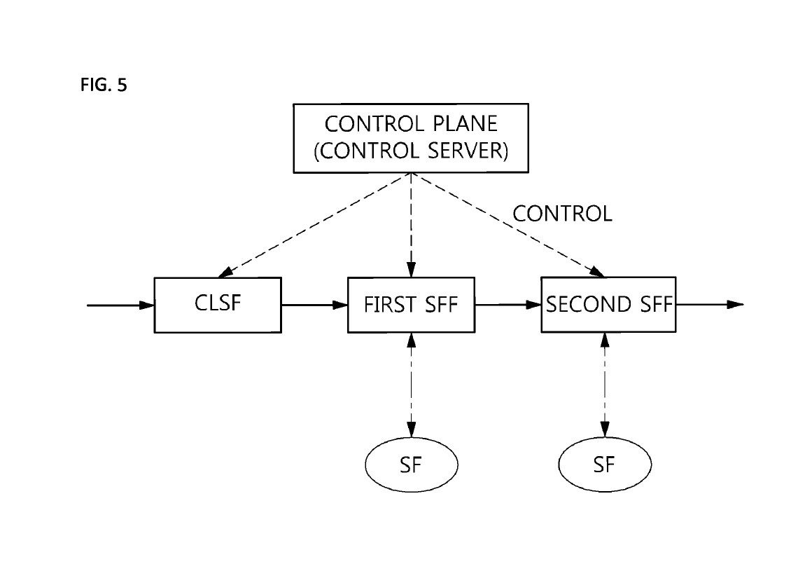

An example of the control of a service chain described with reference to FIG. 5 below.

FIG. 5 shows the control of an SFP according to an example.

A control plane (or a control server) may control a CLSF, a first SFF, and a second SFF.

The control plane may control the SFFs. The SFFs controlled by the control plane may configure and/or reconfigure a service chain. For example, the control plane may configure an SFP adapted to process traffic. Furthermore, when the failure of the SFP occurs for a reason, such as the failure of an SFF, the control plane may instruct the CLSF, the first SFF and the second SFF to reconfigure the SFP.

The reconfiguration of the SFP by the control plane, such as that described above, may be achieved through communication between the control plane and the SFFs. The SFFs are included in a data plane, and the communication may require additional response time between the control plane and the data plane. Accordingly, the reconfiguration of the SFP by the control plane may not be suitable for a network service that requires high response performance.

In the following, a method of reconfiguring an SFP through only interaction between SFFs in a data plane without the intervention of a control plane according to an exemplary embodiment is described. The self recovery of an SFP can be rapidly achieved via communication and a protocol between SFFs. In this case, no intervention of the control plane in the reconfiguration of the SFP may not mean that the intervention of the control plane is completely excluded from the reconfiguration of the SFP. In other words, the reconfiguration of the SFP without the intervention of the control plane may mean that the reconfiguration of the SFP is provided in the form of self recovery in the data plane in order to prevent the operation of the SFF from being interrupted before the completion of the reconfiguration of the SFP by the control plane.

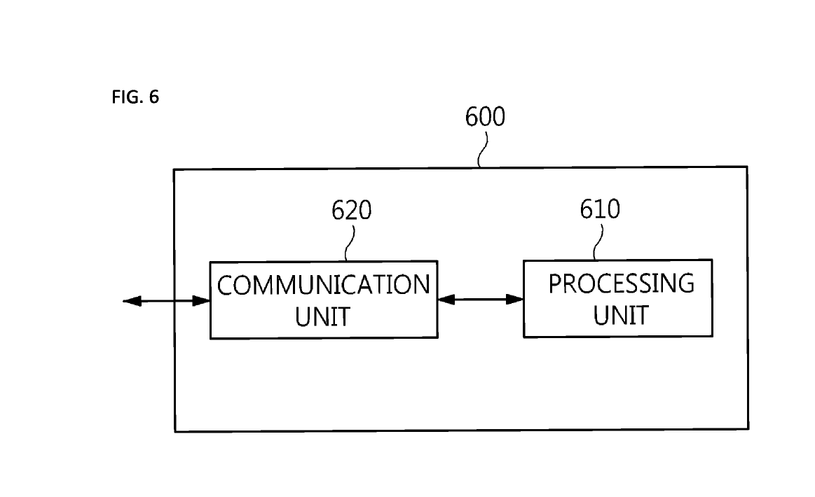

FIG. 6 is a block diagram of an SFF 600 according to an embodiment.

The SFF 600 may include a processing unit 610 and a communication unit 620.

The processing unit 610 may process tasks required for the operation of the SFF 600.

The communication unit 620 may transmit data to another device within a network system, and may receive data from another device. For example, the communication unit 610 may communicate with an SFI, another SFF and a CLSF within the network system.

The operations of a processing unit 610 and a communication unit 620 according to an exemplary embodiment are described in detail below.

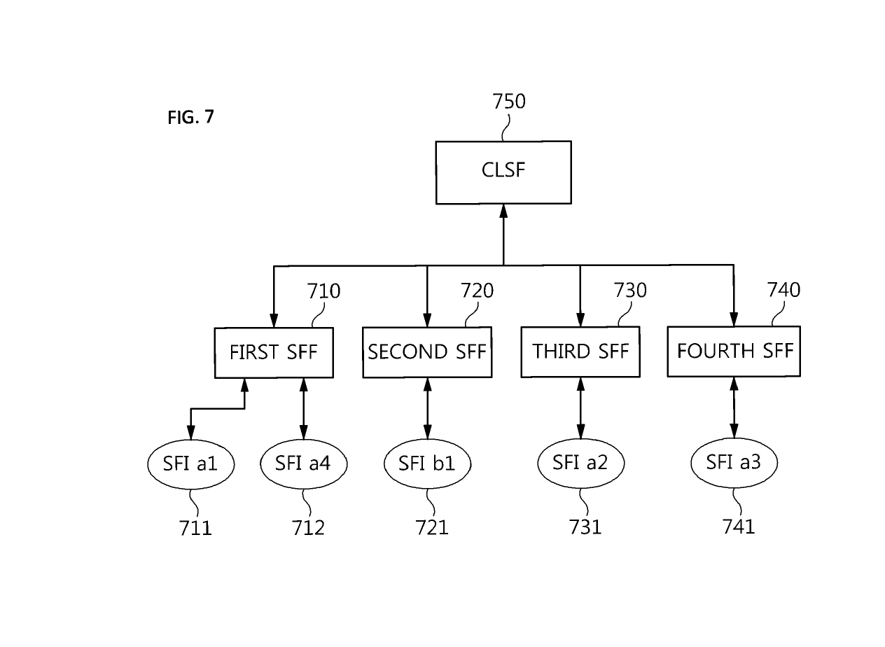

FIG. 7 shows a network system according to an embodiment.

The network system 700 may include a plurality of SFFs and a CLSF 750. In FIG. 7, a first SFF 710, a second SFF 720, a third SFF 730, and a fourth SFF 740 are shown as an example of the plurality of SFFs.

The first SFF 710, the second SFF 720, the third SFF 730, and the fourth SFF 740 may each correspond to the above-described SFF 600 with reference to FIG. 6. Furthermore, the processing unit of the first SFF 710, the processing unit of the second SFF 720, the processing unit of the third SFF 730, and the processing unit of the fourth SFF 740 each correspond to the processing unit 610 of the above-described SFF 600. Moreover, the communication unit of the first SFF 710, the communication unit of the second SFF 720, the communication unit of the third SFF 730, and the communication unit of the fourth SFF 740 may each correspond to the communication unit 620 of the above-described SFF 600. The plurality of SFFs may communicate with each other using the communication units.

Each of the plurality of SFFs may be locally connected one or more SFIs. In FIG. 7, the first SFF 710 is connected to an SFI a1 711 and an SFI a4 712. The second SFF 720 is connected to an SFI b1 721. The third SFF 730 is connected to an SFI a2 731. The fourth SFF 740 is connected to an SFI a3 741. The SF a may be implemented in the SFI a1 711, the SFI a2 731, the SFI a3 741, and the SFI a4 712, and the SF b may be implemented in the SFI b1 721. For example, the SFI a1 711, the SFI a2 731, the SFI a3 741 and the SFI a4 712 may be interchangeable with one another in order to provide the SF a.

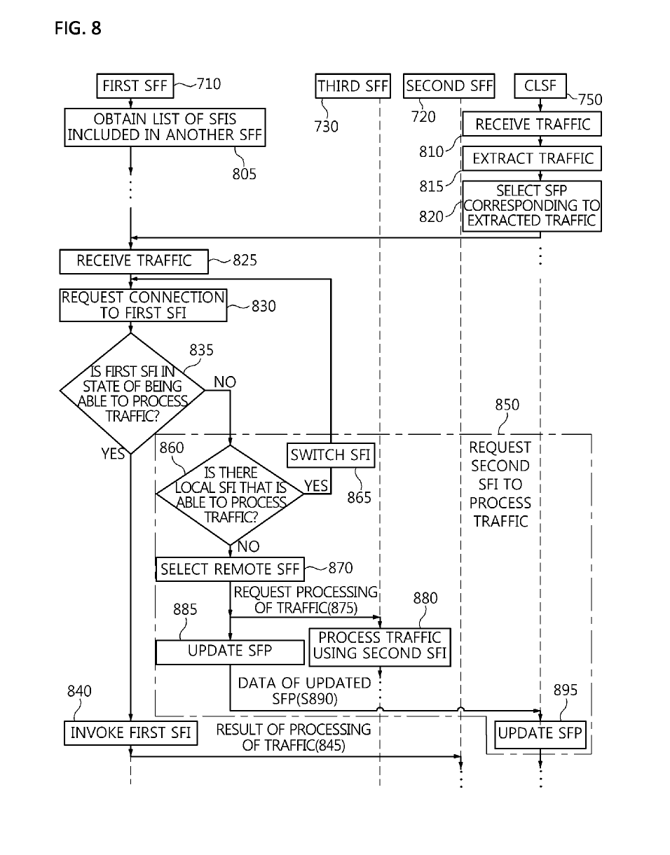

FIG. 8 is a flowchart of a method by which an SFF processes traffic according to an embodiment.

At step 805, a plurality of SFFs may obtain a list of SFIs connected to another SFFs. With the obtainment of the list, each of the plurality of SFFs may become aware of SFIs locally connected to the other SFF.

The communication unit of the first SFF 710 may obtain a list of SFIs connected to another SFFs. According to an exemplary embodiment, the communication unit of the first SFF 710 may obtain a list of SFIs connected to another SFFs via overlay network communication or a communications with control plane components which have centralized orchestration capabilities.

In FIG. 8, a second SFF 720 and a third SFF 730 are illustrated as other SFFs for the first SFF 710.

Each SFF may maintain and update information about SFIs included in another SFF within a network system by obtaining a list of SFIs.

Step 805 may be repeatedly performed, and may be periodically repeated.

At step 815, the CLSF 750 may receive traffic.

At step 816, the CLSF 750 may extract incoming traffic via a communication unit.

At step 820, the CLSF 750 may select an SFP corresponding to the extracted traffic. For example, the CLSF 750 may identify an SFP corresponding to the extracted traffic among SFPs within a network.

The first SFI may be an SFI selected in accordance with an SFP for traffic. The first SFI may be an SFI that is locally connected to the first SFF 710, and may be an SFI that implements a SF to process traffic. For example, when an SFP for traffic is identified, the processing unit of the first SFF 710 may select an SFI implementing an SF on the SFP, among one or more SFIs locally connected to the first SFF 710, as an SFI to process the traffic.

At step 825, traffic may be transmitted to the first SFF 710 connected to the first SFI, and the communication unit of the first SFF 710 may receive the traffic.

At step 830, the communication unit of the first SFF 710 may request a connection to the first SFI.

At step 835, the processing unit of the first SFF 710 may determine whether the first SFI is in the state of being able to process traffic. The processing unit of the first SFF 710 may determine whether the first SFI is in the state being able to process traffic.

The processing unit of the first SFF 710 may determine that the first SFI is in the state of being unable to process traffic when a timeout for the connection request made at step 830 occurs. Alternatively, the processing unit of the first SFF 710 may determine that the SFI is in the state of being unable to process traffic when the communication unit receives the rejection of the connection request, made at step 830, from the first SFI. For example, when the first SFI is in a failure state, a timeout for the connection request made at step 830 may occur. Furthermore, when an excessive load or error occurs in the first SFI, the first SFI is unable to process traffic, and thus the first SFI may transmit the rejection of the connection request to the communication unit of the first SFF 710.

When it is determined that the first SFI is in the state of being able to process traffic, step 840 may be performed. When it is determined that the first SFI is in the state of being unable to process traffic, step 850 may be performed.

At step 840, the communication unit of the first SFF 710 may invoke the first SFI in order to process the traffic.

At step 845, the communication unit of the first SFF 710 may transmit the result of the processing of the traffic to a next SFF subsequent to the first SFF 710 in accordance with the SFP for the traffic. The next SFF may be specified in the SFP for the traffic. In FIG. 8, the second SFF 720 is shown as the next SFF subsequent to the first SFF 710.

At step 850, when the first SFI is unable to process the traffic, the communication unit of the first SFF 710 may request the second SFI implementing an SF, to process the traffic. For example, an agent that processes an SF on the SFP may be changed from the first SFI to the second SFI. The first SFF 710 enables the second SFI to process the traffic on behalf of the first SFI in the state of being unable to process the traffic, thereby recovering the SFP for the traffic.

Step 850 may include steps 860, 865, 870, 875, 880, 885, 890 and 895. At steps 860, 865, 870, 875, 880, 885, 890 and 895 below, the processing unit of the first SFF 710 may select the second SFI to process the traffic, from SFIs, locally connected to the first SFF 710, first, and then may determine the second SFI to process the traffic, among SFIs that can be connected to another remote SFF. In this case, the first SFI and the second SFI may be instances implementing the same SF, and may be interchangeable in order to perform the SF. For example, the first SFI may be the SFI a1 711 described above with reference to FIG. 7, and the second SFI may be the SFI a4 712 described above with reference to FIG. 7. Both SFIs may implement the SF a.

At step 860, the processing unit of the first SFF 710 may determine whether there is an SFI, which can process traffic on behalf of the first SFI, among at least one SFI locally connected to the first SFF 710. In other words, the processing unit of the first SFF 710 may determine whether there is another SFI, which implements an SF identical to an SF implemented by the first SFI, among at least one SFI locally connected to the first SFF 710.

When there is an SFI that is able to process traffic on behalf of the first SFI 710, step 865 may be performed. When there is an SFI that is able to process traffic on behalf of the first SFI, step 870 may be performed.

At step 865, the processing unit of the first SFF 710 may select a second SFI from at least one SFI locally connected to the first SFF 710. In other words, an SFI that processes the traffic may be changed from the first SFI to the second SFI.

Once the SFI has been changed, steps 830 and 835 may be repeated. In this case, the connection request performed at step 830 and the determination performed at step 835 may be performed on the new second SFI, not the previous first SFI. In other words, when steps 830 and 835 are repeated as the SFI has been switched, the “first SFI” shown at steps 830 and 835 of FIG. 8 may be interpreted as referring to the “second SFI” before the repetition.

When there is no SFI, which can process traffic on behalf of the first SFI 710, among at least one SFI locally connected to the first SFF 710, the second SFI needs to be selected from SFIs that can be connected to a remote SFF, other than the first SFF 710. For example, the second SFI may be a remote SFI that can be connected to a remote SFF. At steps 870, 875, 880, 885, 890 and 895 below, a case where a second SFI is selected from SFIs that can be connected to a remote SFF is described. For example, the first SFI may be the SFI a1 711 described above with reference to FIG. 7, and the second SFI may be the SFI a2 731 described above with reference to FIG. 7. Both SFIs may implement the SF a.

At step 870, when there is no SFI, which can process traffic on behalf of the first SFI 710, among at least one SFI locally connected to the first SFF 710, the processing unit of the first SFF 710 may select one out of other SFFs of a network system as a remote SFF in accordance with a predetermined criterion. In FIG. 8, the third SFF 730 is shown as being selected as the remote SFF. In the following, the remote SFF may represent the third SFF 730.

In an exemplary embodiment, the processing unit of the first SFF 710 may determine the second SFI, which will process the traffic, using a list of SFIs included in the other SFF described at step 805. The second SFI may be an SFI in the list received at step 805. Furthermore, the processing unit of the first SFF 710 may select an SFF, which can be connected to the second SFI, from one or more SFFs of the network system as the remote SFF.

In an exemplary embodiment, the remote SFF may be an SFF that exhibits the best performance or an optimal or best performance among one or more SFFs in the processing of traffic. The processing unit of the first SFF 710 may select an SFF, which exhibits the best performance or an optimal or best performance among the one or more SFFs in the processing of traffic, as the remote SFF.

In an exemplary embodiment, an SFF of one or more SFFs that has requested the first SFF 710 to process traffic on behalf of it may be excluded from the selection as the remote SFF. When an SFF having requested the processing of traffic is selected as the remote SFF and a request for the processing of traffic is transmitted to the selected remote SFF, a loop of the request for the processing of traffic may occur. To prevent the occurrence of a loop, the processing unit of the first SFF 710 may exclude an SFF that has requested the first SFF 710 of one or more SFFs to process the traffic from the selection of the remote SFF.

At step 875, the communication unit of the first SFF 710 may transmit a request for the processing of the traffic to the remote SFF.

The processing unit of the first SFF 710 may include information about the first SFF 710 in the request for the processing of the traffic. Since the information about the first SFF 710 is included in the request for the processing of the traffic, a loop in which the request for the processing of the traffic is transmitted to the first SFF 710 again may be prevented. For example, when the request for the processing of the traffic is sequentially forwarded to a plurality of SFFs, the request for the processing of the traffic is prevented from being returned to the first SFF 710 by the information about the first SFF 710 included in the request for the processing of the traffic.

The communication unit of the remote SFF may receive the request for the processing of the traffic.

At step 880, the processing unit of the remote SFF may process the traffic using the second SFI.

Once the traffic has been processed by the second SFI, the result of the processing of the traffic may be transmitted to a subsequent SFF according to the SFP of the traffic. In an exemplary embodiment, to transmit the result of the processing of the traffic, a recursive call method and a redirect method may be used. The recursive call method may be a method in which the first SFF receives the result of the processing of traffic from the remote SFF and the first SFF transmits the result of the processing of the traffic to a next SFF. The redirect method may be a method in which the remote SFF transmits the result of the processing of direct traffic to a next SFF.

In an exemplary embodiment, the processing unit of the first SFF 710 may select the method of transmitting the result of the processing of the traffic in accordance with a predetermined condition. For example, the processing unit of the first SFF 710 may select the method of transmitting the result of the processing of the traffic based on the reason of the rejection of the connection request transmitted from the first SFI.

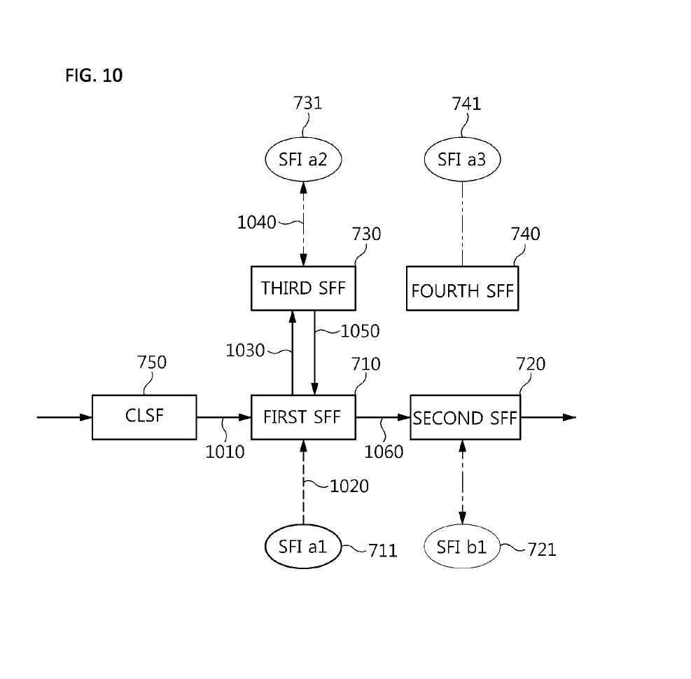

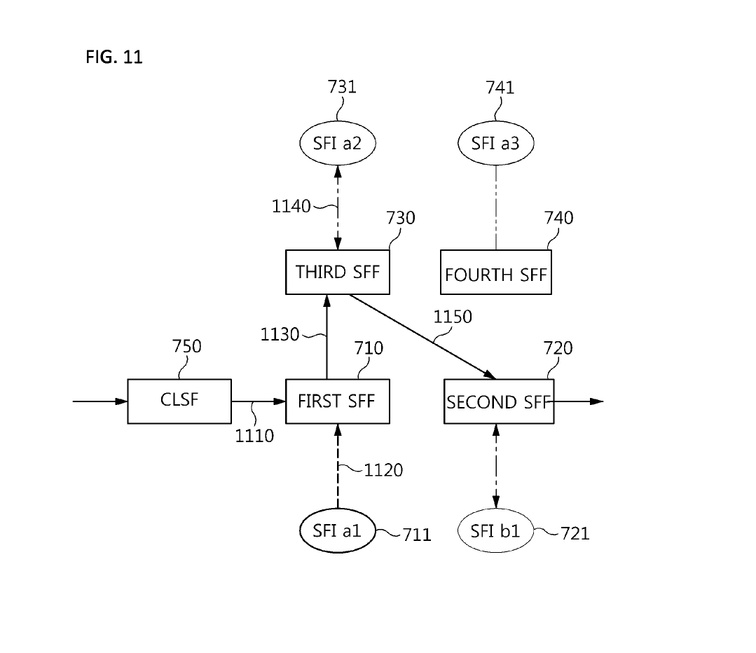

A recursive call recursive method and a redirect method according to exemplary embodiments are described with reference to FIGS. 10 and 11, respectively, below.

At step 885, the processing unit of the first SFF 710 may update the SFP for the traffic to use the second SFI in place of the first SFI. The updated SFP may use the second SFI in the processing of an SF.

At step 890, the communication unit of the first SFF 710 may transmit the data of the updated SFP to the CLSF 750.

The CLSF 750 may receive the data of the updated SFP.

At step 895, the CLSF 750 may update the SFP using the data of the updated SFP. As the CLSF 750 updates the SFP, the second SFI may process the traffic on behalf of the existing first SFI in the overall network system, and the switching of the SFI may occur no longer.

Steps 885, 890 and 895 may be selectively performed. For example, when the switching of the processing of traffic from the first SFI to the second SFI is performed at a predetermined or higher frequency or a predetermined or larger number of times, the communication unit of the first SFF 710 may update the SFP, and may transmit the data of the updated SFP to the CLSF 750. Alternatively, when the communication unit of the first SFF 710 repeatedly receives the rejection of a connection request from the first SFI or when the processing unit of the first SFF 710 determines that the state of the first SFI is the state of being unrecoverable, and the communication unit of the first SFF 710 may transmit the data of the updated SFP to the CLSF 750.

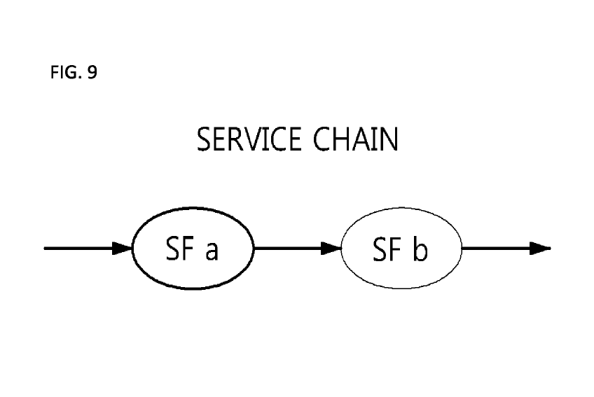

FIG. 9 shows a service chain according to an example.

As shown in FIG. 9, traffic may be sequentially processed by an SF a and an SF b. In the following, the service chain sequentially processed by the SF a and the SF b is represented by an “SFC {SF a, SF b}.” Furthermore, when an SFP adapted to process an “SFC {SF a, SF b}” sequentially includes an SF a1 and an SF b1, the SFP is represented by an “SFP {SF a1, SF b1}.”

The service chain may sequentially connect SFs that are distributed to provide a network service in an NFV or SFC. When at least one SF fails during the execution of SFs, the service chain may be reconfigured to use another SF.

Scenarios for processing traffic through the reconfiguration of a service chain are described in detail below with reference to FIGS. 10 to 14, respectively. In FIGS. 10 to 14, an SFI a1 711, an SFI a2 731 and an SFI a3 741 may be instances adapted to implement an SF a, and an SFI b1 721 may be an instance adapted to implement an SF b.

FIG. 10 illustrates the processing of traffic using a recursive call method according to an example.

At step 1010, the CLSF 750 may determine an “SFP {SF a1, SF b1} for a given “SFC {SF a and SF b}.”

At step 1020, an SFI a1 711 may transmit the rejection of a connection request to the communication unit of a first SFF 710. The SFI a1 711 may correspond to the above-described first SFI with reference to FIG. 8.

Since the rejection of a connection request has been transmitted from the SFI a1 711, the first SFF 710 may not provide an SF a. Accordingly, the first SFF 710 may entrust the processing of traffic to another SFF, which provides the SF a, among one or more SFFs of a network system.

At step 1030, the processing unit of the first SFF 710 may select another SFF, which provides the SF a, among one or more SFFs of a network system, as a remote SFF. In FIG. 10, the third SFF 730 has been selected as the remote SFF.

As the remote SFF is selected, the processing of the traffic may be entrusted. In the following, the entrustment of the processing of traffic according to the recursive call method is described.

The communication unit of the first SFF 710 may request the processing of traffic to the selected remote SFF. In this case, the processing of the traffic may mean the execution of the SF a for the traffic.

At step 1040, the SFI a2 731 connected to the third SFF 730 may perform the processing of the traffic, and may transmit the result of the processing of the traffic to the communication unit of the third SFF 730. The SFI a2 731 may correspond to the above-described second SFI with reference to FIG. 8.

At step 1050, the communication unit of the remote SFF may transmit the result of the processing of the traffic to the communication unit of the first SFF 710. The communication unit of the first SFF 710 may receive the result of the processing of the traffic from the remote SFF.

At step 1060, the communication unit of the first SFF 710 may transmit the result of the processing of the traffic to a next SFF subsequent to the first SFF 710 in accordance with an SFP for the traffic. In FIG. 10, a second SFF 720 connected to an SFI b1 721 is shown as the subsequent SFF.

As the result of the processing of the traffic is transmitted from the third SFF 730, the processing unit of the first SFF 710 resumes the SFP for the traffic. The communication unit of the first SFF 710 may transmit traffic to the second SFF 720 connected to the SFI b 1 721 in order to execute an SF b 1 for the traffic.

The steps of the above-described embodiment may correspond to the above-described steps with reference to FIG. 8. For example, step 835 may include step 1020. Step 1030 may correspond to steps 870 and 875. Furthermore, step 880 may include steps 1040, 1050 and 1060. In other words, the method of processing traffic using the recursive call method at step 880 may include steps 1040, 1050 and 1060.

FIG. 11 illustrates the processing of traffic using retransmission according to an example.

At step 1110, a CLSF 750 may determine an “SFP {SF a1, SF b1} for a given “SFC {SF a and SF b}.”

At step 1120, an SFI a1 711 may transmit the rejection of a connection request to the communication unit of a first SFF 710. The SFI a1 711 may correspond to the above-described first SFI with reference to FIG. 8.

Since the rejection of a connection request has been transmitted from the SFI a1 711, the first SFF 710 may not provide an SF a. Accordingly, the first SFF 710 may entrust the processing of traffic to another SFF, which provides the SF a, among one or more SFFs of a network system.

At step 1130, the processing unit of the first SFF 710 may select an SFF, which provides the SF a, from one or more SFFs of the network system as a remote SFF. In FIG. 11, a third SFF 730 has been selected as the remote SFF.

As the remote SFF is selected, the processing of the traffic may be entrusted. In the following, the entrustment of the processing of traffic according to the retransmission method is described.

The communication unit of the first SFF 710 requests the processing of the traffic to the selected remote SFF. In this case, the processing of the traffic may mean the execution of an SF a for the traffic.

At step 1140, an SFI a2 731 connected to the third SFF 730 may perform the processing of the traffic, and may transmit the result of the processing of the traffic to the third SFF 730. The SFI a2 731 may correspond to the above-described second SFI with reference to FIG. 8.

At step 1150, the communication unit of the remote SFF may directly transmit the result of the processing of the traffic to a next SFF subsequent to the first SFF 710 in accordance with an SFP for the traffic. In FIG. 11, a second SFF 720 connected to an SFI b1 721 is shown as the subsequent SFF. The result of the processing of the traffic by the third SFF 730 may be directly transmitted to the second SFF 720, i.e., a subsequent SFF, without passing through the first SFF 710.

As the result of the processing of the traffic is transmitted from the SFI a2 731, the processing unit of the third SFF 730 may resume the SFP for the traffic, and may transmit traffic to a second SFF 720 connected to the SFI b1 721 in order to execute an SF b1 for the traffic.

The steps of the above-described embodiment may correspond to the above-described steps with reference to FIG. 8. For example, step 835 may include step 1120. Step 1130 may correspond to steps 870 and 875. Furthermore, step 880 may include steps 1140 and 1150. In other words, the method of processing traffic using the retransmission redirect method at step 880 may include step 1140.

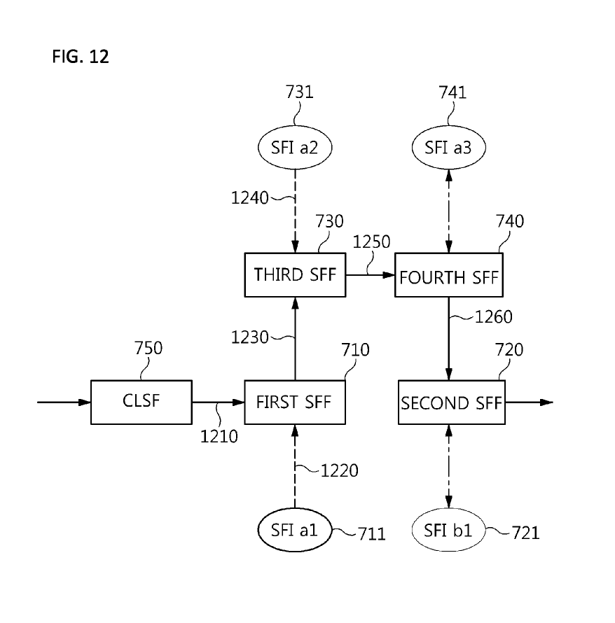

FIG. 12 illustrates the processing of traffic using repeated retransmission according to an example.

At step 1210, a CLSF 750 may determine an “SFP {SF a1, SF b1} for a given “SFC {SF a and SF b}.”

At step 1220, an SFI a1 711 may transmit the rejection of a connection request to the communication unit of a first SFF 710. The SFI a1 711 may correspond to the above-described first SFI with reference to FIG. 8.

Since the rejection of a connection request has been transmitted from the SFI a1 711, the first SFF 710 may not provide an SF a. Accordingly, the first SFF 710 may entrust the processing of traffic to another SFF, which provides an SF a, among one or more SFFs of a network system.

At step 1230, the processing unit of the first SFF 710 may select another SFF, which provides an SF a, from one or more SFFs of the network system as a remote SFF. In FIG. 10, the third SFF 730 has been selected as the remote SFF.

As the remote SFF is selected, the processing of the traffic may be entrusted. In the following, the entrustment of the processing of the traffic according to the retransmission method is described.

The communication unit of the first SFF 710 may request the processing of the traffic to the selected remote SFF. In this case, the processing of the traffic may mean the execution of the SF a for the traffic.

At step 1240, the SFI a2 731 may transmit the rejection of a connection request to the communication unit of the third SFF 730.

Since the rejection of the connection request has been transmitted from the SFI a2 731, the third SFF 730 may not also provide the SF a. Accordingly, the third SFF 730 may entrust the processing of the traffic to another SFF, which provides the SF a, among one or more SFFs of the network system.

In an exemplary embodiment, the request for the processing of the traffic transmitted from the first SFF 710 at step 1230 may include information about the first SFF 710. The processing unit of the third SFF 730 may exclude the first SFF 710 having transmitted the request for the processing of the traffic from the selection of the remote SFF using information included in the request for the processing of the traffic transmitted to the third SFF 730.

At step 1250, the processing unit of the third SFF 730 may select an SFF, which provides the SF a, from one or more SFFs of the network system as the remote SFF. In FIG. 12, a fourth SFF 740 has been selected as the remote SFF.

As the remote SFF is selected, the processing of traffic may be entrusted again.

The communication unit of the third SFF 730 may request the processing of the traffic to the selected remote SFF. In this case, the processing of the traffic may mean the execution of the SF a for the traffic.

An SFI a3 741 connected to a fourth SFF 740 may perform the processing of the traffic, and may transmit the result of the processing of the traffic to the fourth SFF 740. The SFI a3 741 may correspond to the above-described second SFI with reference to FIG. 8.

At step 1260, the communication unit of the fourth SFF 740 may directly transmit the result of the processing of the traffic to a next SFF subsequent to the first SFF 710 in accordance with the SFP for the traffic. In FIG. 10, a second SFF 720 connected to an SFI b1 721 is shown as the subsequent SFF. The result of the processing of the traffic by the fourth SFF 740 may be directly transmitted to the second SFF 720, i.e., a subsequent SFF, without passing through the first SFF 710 and the third SFF 730.

As the result of the processing of the traffic is transmitted from the SFI a3 741, the processing unit of the fourth SFF 740 may resume the SFP for the traffic, and may transmit the traffic to the second SFF 720 connected to the SFI b1 721 in order to execute the SF b1 for the traffic.

The steps of the above-described embodiment may correspond to the above-described steps with reference to FIG. 8. For example, step 835 may include step 1220. Step 1230 may correspond to steps 870 and 875. Furthermore, step 880 may include steps 1240 and 1250. In other words, the method of processing traffic using the retransmission redirect method at step 880 may include steps 1240 and 1250.

Furthermore, step 1250 may be considered as steps 825, 830, 835 and 850 described above with reference to FIG. 8 being performed by the third SFF 730, not the first SFF 710. In other words, when a request for the processing of the traffic based on the retransmission method is repeated, the first SFF 710 may perform the steps of the embodiment described above with reference to FIG. 8, and then the third SFF 730 may perform the steps of the embodiment described above with reference to FIG. 8. Furthermore, the fourth SFF 740 may be a remote SFF that processes the traffic.

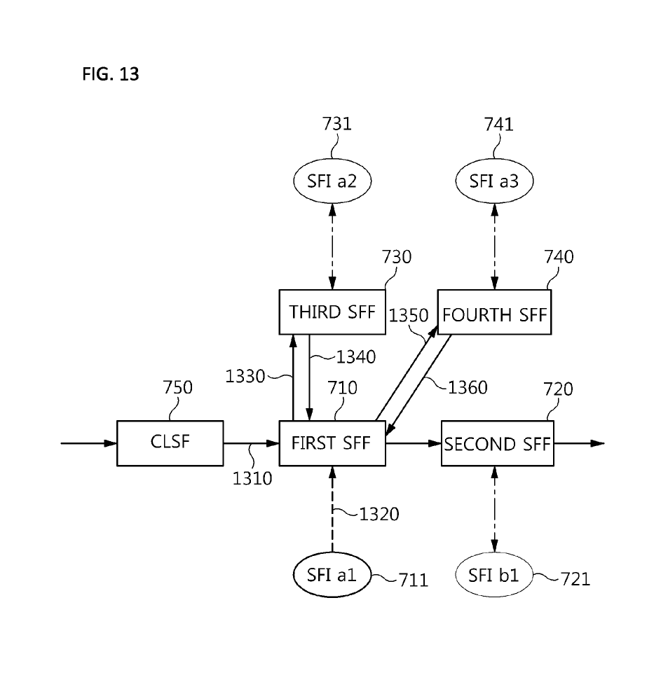

FIG. 13 illustrates the processing of traffic using broadcasting according to an example.

At step 1310, a CLSF 750 may determine an “SFP {SF a1, SF b1} for a given “SFC {SF a and SF b}.”

At step 1320, an SFI a1 711 may transmit the rejection of a connection request to the communication unit of a first SFF 710. The SFI a1 711 may correspond to the first SFI described above with reference to FIG. 8.

Since the rejection of a connection request has been transmitted from the SFI a1 711, the first SFF 710 may not provide an SF a. Accordingly, the first SFF 710 may entrust the processing of traffic to another SFF, which provides the SF a, among one or more SFFs of a network system.

At step 1330, the processing unit of the first SFF 710 may select an SFF, which provides the SF a, from one or more SFFs of the network system as a remote SFF. The selected remote SFF may include a plurality of SFFs. In FIG. 10, the third SFF 730 and the fourth SFF 740 have been selected as the plurality of remote SFFs.

As the remote SFFs are selected, the processing of the traffic may be entrusted. In the following, the entrustment of the processing of traffic based on the recursive call method is described.

The communication unit of the first SFF 710 may request the processing of the traffic to each of the plurality of selected remote SFFs. The communication unit of the first SFF 710 may simultaneously request the processing of the traffic from the plurality of selected remote SFFs via broadcasting. In this case, the processing of the traffic may mean the execution of the SF a for the traffic.

In this case, the broadcasting is not limited to Internet Protocol (IP) broadcasting, and may refer to an operation of simultaneously requesting the processing of the traffic to the plurality of remote SFFs through a single procedure performed in the communication unit of the first SFF 710.

At step 1340, each of the plurality of remote SFFs may perform the processing of the traffic. An SFI a2 731 connected to the third SFF 730 may perform the processing of the traffic, and may transmit the result of the processing of the traffic to the communication unit of the third SFF 730. An SFI a3 741 connected to the fourth SFF 740 may perform the processing of the traffic, and may transmit the result of the processing of the traffic to the fourth communication unit of the SFF 740. Each of the SFI a2 731 and the SFI a3 741 may correspond to the second SFI described above with reference to FIG. 8.

At step 1350, the plurality of remote SFFs may transmit the results of the processing of the traffic to the communication unit of the first SFF 710. Each of the communication unit of the third SFF 730 and the communication unit of the fourth SFF 740 may transmit the result of the processing of the traffic to the communication unit of the first SFF 710. The communication unit of the first SFF 710 may receive the results of the processing of the traffic from the plurality of remote SFFs.

The processing unit of the first SFF 170 may select the result of the processing of a single stream of traffic in accordance with a predetermined condition from the results of the processing of the traffic transmitted from the plurality of remote SFFs, and may ignore the results of the processing of the remaining traffic. For example, the processing unit of the first SFF 710 may select the result of the processing of the traffic, which is transmitted to the first SFF 710 first, from the results of the processing of the traffic transmitted from the plurality of remote SFFs.

At step 1360, the communication unit of the first SFF 710 may transmit the selected result of the processing of the traffic to a next SFF subsequent to the first SFF 710 in accordance with an SFP for the traffic. In FIG. 10, the second SFF 720 connected to the SFI b1 721 is shown as the subsequent SFF.

As the results of the processing of the traffic are transmitted from the plurality of SFFs, the processing unit of the first SFF 710 may resume the SFP for the traffic. The communication unit of the first SFF 710 may transmit the traffic to a second SFF 720 connected to an SFI b1 721 in order to execute an SF b1 for the traffic.

The steps of the above-described embodiment may correspond to the steps described above with reference to FIG. 8. For example, step 835 may include step 1320. Step 1330 may correspond to steps 870 and 875. Furthermore, step 880 may include steps 1340, 1350 and 1360. In other words, the method of processing the traffic using the recursive call method at step 880 may include steps 1340, 1350 and 1360.

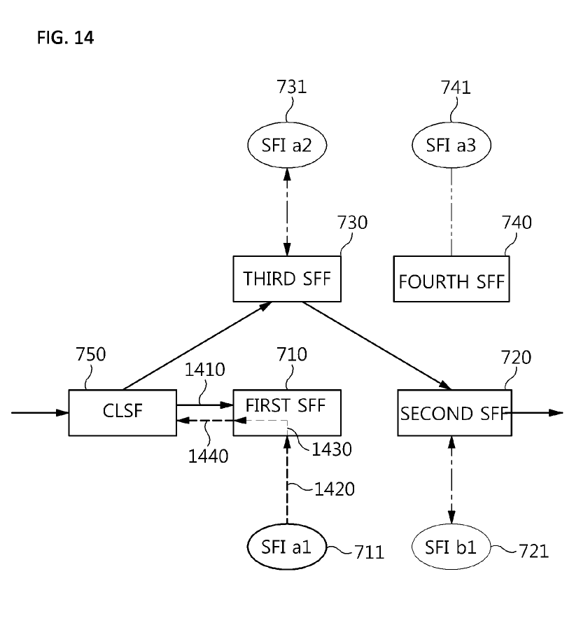

FIG. 14 illustrates the update of an SFP according to an example.

At step 1410, a CLSF 750 may determine an “SFP {SF a1, SF b1} for a given “SFC {SF a and SF b}.”

At step 1420, an SFI a1 711 may transmit the rejection of a connection request to the communication unit of the first SFF 710. The SFI a1 711 may correspond to the first SFI described above with reference to FIG. 8.

Since the rejection of a connection request has been transmitted from the SFI a1 711, the first SFF 710 may not provide an SF a.

At step 1430, the processing unit of the first SFF 710 may determine that the SFI a1 711 is in the state of being unable to continuously process the SF a. For example, when the rejection of a connection request is continuously transmitted from the SFI a1 711, the processing unit of the first SFF 710 may determine that the SFI a1 711 is in the state of being unable to continuously process the SF a.

When it is determine that the SFI a1 711 is in the state of being unable to continuously process the SF a, the processing unit of the first SFF 710 may update an SFP for the traffic so that the SFI a1 711 is not used.

According to an exemplary embodiment, an SFI that is used in place of the SFI a1 711 in the SFP may an SFI to which the processing of the traffic is finally entrusted. For example, the processing unit of the first SFF 710 may update the SFP for the traffic so that an SFI a2 731 previously selected for the entrustment of the processing of the traffic is used in place of the SFI a1 711.

At step 1440, the communication unit of the third SFF 730 may transmit the data of the updated SFP to the CLSF 750. When the data of the updated SFP is transmitted, the CLSF 750 may update the SFP using the data of the updated SFP. For example, the CLSF 750 may update the SFP to an “SFP {SF a2, SF b1}” so that the SFI a2 731 previously selected for the entrustment of the processing of the traffic is used in place of the SFI a1 711. As the SFP is updated, the “SFP {SF a2, SF b1}” intended for the processing of traffic may be used in a network system thereafter.

The steps of the above-described embodiment may correspond to the steps described above with reference to FIG. 8. For example, step 1420 may correspond to step 885. Step 835 may correspond to step 1420. Step 885 may correspond to step 1430. Steps 890 and 895 may correspond to step 1440.

A method according to at least one embodiment of the present invention may be may be implemented as a computer program instructions that can be executed by various computer means or various computer components. The computer-readable storage medium may include program instructions, data files, and data structures solely or in combination. The computer program instructions stored on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as Compact Disk (CD)-Read Only Memory (ROM) and a Digital Versatile Disk (DVD), magneto-optical media, such as a floptical disk, ROM, Random Access Memory (RAM), and flash memory. Examples of the program instructions include machine code, such as code created by a compiler, and high-level language code executable by a computer using an interpreter. The hardware devices may be configured to operate as one or more software modules in order to perform the operation of the present invention, and the vice versa.

In accordance with at least one embodiment of the present invention, when an SFI is in the state of being unable to process traffic, the traffic is processed using another SFI that implements an SF identical to an SF that is implemented by the former SFI.

In accordance with at least one embodiment of the present invention, an SFP for traffic is recovered by using another SFI in place of an SFI in the state of being unable to process the traffic.

In accordance with at least one embodiment of the present invention, an SFP is recovered via interaction between SFFs.

While the embodiments have been described in connection with the limited embodiments and drawings, it will be apparent to those having ordinary knowledge in the art that various modifications and alternations can be made based on the above description. For example, although the described technologies are performed in sequences different from those of the described methods, and/or the components of the described systems, structures, apparatuses, circuits, etc. are coupled and combined in forms different from those of the described methods or are replaced with other components or equivalents, appropriate results can be achieved.

Therefore, other implementations, other embodiments and equivalents to the claims fall within the scope of the attached claims.

What is claimed is:

1. A method in which a Service Function Forwarding node (SFF) processes traffic, the method comprising:
determining whether a first Service Function Instance (SFI) that is locally connected to the SFF and implements a Service Function (SF) intended for processing of traffic is in a state of being able to process the traffic; and
requesting the processing of the traffic to a second SFI in which the SF has been implemented when the first SFI is in a state of being unable to process the traffic.

2. The method of claim 1, wherein the first SFI is an SFI that is selected in accordance with a Service Function Path (SFP) for the traffic.

3. The method of claim 1, wherein the SFF recovers a Service Function Path (SFP) for the traffic by allowing the second SFI to process the traffic on behalf of the first SFI that is in a state of being unable to process the traffic.

4. The method of claim 1, further comprising requesting a connection to the first SFI;
wherein the SFF determines that the first SFI is in a state of being unable to process the traffic when a timeout for the connection request occurs.

5. The method of claim 1, further comprising requesting a connection to the first SFI;
wherein the SFF determines that the first SFI is in a state of being unable to process the traffic when the SFF receives a rejection of the connection request from the first SFI.

6. The method of claim 1, wherein the SFF selects the second SFI from at least one SFI locally connected to the SFF.

7. The method of claim 1, wherein the second SFI is a remote SFI that is connected to a remote SFF.

8. The method of claim 7, further comprising obtaining a list of SFIs connected to other SFFs;
wherein the second SFI is an SFI within the list.

9. The method of claim 8, wherein the SFF obtains the list via overlay network communications with the other SFFs.

10. The method of claim 8, wherein the SFF obtains the list via a communications with control plane components which have centralized orchestration capabilities.

11. The method of claim 7, wherein the requesting comprises transmitting a request for the processing of the traffic to the remote SFF.

12. The method of claim 11, wherein the requesting further comprises:
receiving a result of the processing of the traffic from the remote SFF; and
transmitting the result to a next SFF in accordance with an SFP for the traffic.

13. The method of claim 11, wherein the result of the processing of the traffic is transmitted by the remote SFF directly to a next SFF specified in an SFP for the traffic.

14. The method of claim 11, further comprising selecting one out of one or more SFFs as the remote SFF in accordance with a predetermined criterion.

15. The method of claim 14, wherein the remote SFF is an SFF that exhibits a best performance among the one or more SFFs in the processing of the traffic.

16. The method of claim 14, wherein an SFF that has requested the processing of the traffic from the SFF among the one or more SFFs is excluded from the selection as the remote SFF.

17. The method of claim 1, wherein:
a number of the remote SFFs is plural; and
the SFF requests the processing of the traffic to the plurality of remote SFFs via broadcasting.

18. The method of claim 1, further comprising:
updating an SFP for the traffic so that the second SFI is used in place of the first SFI; and
transmitting data of the updated SFP to a traffic classification node.

19. A Service Function Forwarding node (SFF), comprising:
a processing unit configured to detect whether a first Service Function Instance (SFI) that is locally connected to the SFF and implements a Service Function (SF) intended for processing of traffic is in a state of being able to process the traffic; and
a communication unit configured to request the processing of the traffic from a second SFI in which the SF has been implemented.

20. A network system including a plurality of Service Function Forwarding nodes (SFFs), the network system comprising:
a first Service Function Forwarding node (SFF) locally connected to a first Service Function Instance (SFI) that implements a Service Function (SF) for processing of traffic; and
a second SFF locally connected to a second SFI in which the SF has been implemented;
wherein the first SFF detects the first SFI being in a state of being unable to process the traffic, and requests processing of the traffic to the second SFF when there is no other SFI implementing the SF and locally connected to the first SFI; and
wherein the second SFF processes the traffic using the second SFI.
